(19) United States
(12) Patent Application Publication
(10) Pub. No.: US 2008/0060074 A1
(43) Pub. Date: Mar. 6, 2008

(54) Intrusion detection system, intrusion detection method, and communication apparatus using the same

(75) Inventor: Yoshiaki Okuyama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/896,720

(22) Filed: Sep. 5, 2007

(30) Foreign Application Priority Data
Sep. 6, 2006 (JP) 2006-240915

(51) Int. Cl. G06F 11/30

(52) U.S. Cl. 726/23

(57) ABSTRACT

There is provided an intrusion detection system which performs pattern matching between a reception packet and an intrusion detection rule. The intrusion detection system comprises: an inline-type intrusion detection unit for performing pattern matching between the reception packet and the intrusion detection rule before an application processes the reception packet; and a cancellation notification generation unit for generating a pattern matching cancellation notification while the pattern matching is performed by the inline-type intrusion detection unit. The inline-type intrusion detection unit is configured to cancel the pattern matching in response to the pattern matching cancellation notification.

### INCORPORATION BY REFERENCE

This application is based upon and claims the benefit of priority from Japanese patent application No. 2006-240915, filed on Sep. 6, 2006, the disclosure of which is incorporated herein in its entirety by reference.

### BACKGROUND OF THE INVENTION

1. Field of the Invention

The present invention relates to an intrusion detection system, an intrusion detection method, and a communication apparatus using the same. More particularly, the present invention relates to an intrusion detection system for detecting unauthorized access from a communication network including the Internet.

2. Description of the Related Art

The number of network attacks, such as web page alteration or DoS (Denial of Service) attack, plotted as a first step for intruding into a system goes on increasing. It is difficult to prevent such network attacks only using a conventional firewall. As a countermeasure against such network attacks, there is available an IDS (Intrusion Detection System). The IDS system detects abnormal packets (hereinafter, referred to as “intrusion”) indicating intrusion into a network terminal and DoS attack and notifies a network administrator of the detected intrusion. At the present day, where searching operation for finding security holes or actual attempts of intrusion become everyday events, the IDS is regarded as an indispensable system for managing a network.

The IDS has a mechanism of performing matching between a communication packet and a pattern for detecting intrusion so as to detect intrusion. This pattern is hereinafter referred to as “intrusion detection rule”. There are available two methods by which the IDS perform the matching between a communication packet and intrusion detection rule. One is an inline-type and the other is non-inline-type. In the non-inline-type IDS, the pattern matching for a packet (hereinafter, referred to as “terminal reception packet”) processed by a protocol such as TCP/IP is performed in parallel with packet reception processing by an application. On the other hand, in the inline-type IDS, a terminal reception packet is delivered to packet reception processing by an application after the pattern matching for the terminal reception packet has completed.

Since the pattern matching for the terminal reception packet is performed in parallel with the packet reception processing by an application in the non-inline-type IDS, even when an abnormal packet inducing intrusion is detected by the IDS, there is a possibility that the abnormal packet has been processed by an application. In addition, if a processor cannot keep up with incoming packet streams, unchecked packets that have not been subjected to the pattern matching occur.

The inline-type IDS has been developed for solving the above problem. The inline-type IDS can detect a packet inducing intrusion before the packet reception processing is performed by an application and, thereby, can prevent unchecked packets from occurring. However, in the case where the packet matching processing takes much time, since the packet matching processing for the terminal reception packet needs to be executed before the packet processing by an application, processing delay correspondingly occurs.

As a related art of the present invention, there is known a technique disclosed in Patent Document 1 (JP-2006-121679-A). In this technique, the IDS determines whether or not to execute the matching between a packet and intrusion detection rule using the transmission source IP address of the packet and port number thereof. Further, in this technique, the IDS can control execution/nonexecution of the pattern matching on an address by address or protocol by protocol basis. However, in order to prevent processing delay of a packet requiring a real-time processing from occurring, there is no method but to select nonexecution of the pattern matching.

The problems relating to the abovementioned related art are summarized as follows. The first problem is that when the number of intrusion detection rules is increased in an apparatus such as a mobile terminal, a network appliance, and a sensor device, whose performance of hardware resources such as processor or memory is limited, a high load is imposed on processing of the IDS, leading to occurrence of unchecked packets. This is because that the number of times of pattern matching is increased as the number of intrusion detection rules to be set is increased with the result that the pattern matching processing cannot be performed for all the packets.

The second problem is that when the number of intrusion detection rules is excessively reduced in order to solve the first problem, security risk is increased. This is because that there is a possibility that an attack corresponding to a removed intrusion detection rule may occur and, if occurs, it is impossible to protect the system from the attack.

The third problem is that when the inline-type IDS is introduced in order to solve the problem of occurrence of unchecked packets, processing delay occurs to deteriorate a real-time processing performance. This is because that the inline-type IDS executes the pattern matching at the time of reception processing of a packet such as a TCP/IP packet and, after that, an application processes the reception packet, so that processing delay occurs by the time corresponding to the pattern matching time.

### SUMMARY OF THE INVENTION

An object of the present invention is to provide an intrusion detection system and its method capable of preventing unchecked packet from occurring by using the inline-type IDS and preventing deterioration in the real-time processing performance due to processing delay, which is a problem caused by a use of the inline-type IDS, and a communication apparatus using the intrusion detection system and its method.

According to a first aspect of the present invention, there is provided an intrusion detection system which performs pattern matching between a reception packet and an intrusion detection rule, comprising: inline-type intrusion detection means for performing pattern matching between the reception packet and the intrusion detection rule before an application processes the reception packet; and cancellation notification generation means for generating a pattern matching cancellation notification while the pattern matching is performed by the inline-type intrusion detection means, wherein the inline-type intrusion detection means is configured to cancel the pattern matching in response to the pattern matching cancellation notification.

According to a second aspect of the present invention, there is provided a communication apparatus which uses the intrusion detection system described above.

According to a third aspect of the present invention, there is provided an intrusion detection method for performing pattern matching between a reception packet and an intrusion detection rule, comprising: an inline-type intrusion detection step of performing pattern matching between the reception packet and the intrusion detection rule before an application processes the reception packet; a cancellation notification generation step of generating a pattern matching cancellation notification while the pattern matching is performed in the inline-type intrusion detection step; and a step of canceling the pattern matching in response to the pattern matching cancellation notification generated in the inline-type intrusion detection step.

According to a fourth aspect of the present invention, there is provided an intrusion detection program, stored in a computer-readable medium, for allowing a computer to execute pattern matching between a reception packet and an intrusion detection rule, comprising: an inline-type intrusion detection processing of performing pattern matching between the reception packet and the intrusion detection rule before an application processes the reception packet; a cancellation notification generation processing of generating a pattern matching cancellation notification while the pattern matching is performed in the inline-type intrusion detection processing; and a processing of canceling the pattern matching processing in response to the pattern matching cancellation notification generated in the inline-type intrusion detection processing.

### BRIEF DESCRIPTION OF THE DRAWINGS

FIG. 1 is a functional block diagram of a first exemplary embodiment of the present invention;

FIG. 2 is a view showing an example of a maximum allowable delay time database 16 of FIG. 1, which serves as a conversion table from protocol identifiers into corresponding maximum allowable delay time;

FIG. 3 is an operation sequence of the first exemplary embodiment of the present invention;

FIG. 4 is a functional block diagram of a second exemplary embodiment of the present invention;

FIG. 5 is a view showing an example of a pattern matching processing time information database 19 of FIG. 4, which serves as a conversion table for obtaining a pattern matching order list based on protocol identifiers;

FIG. 6 is an operation sequence of the second exemplary embodiment of the present invention;

FIG. 7 is a functional block diagram of a third exemplary embodiment of the present invention;

FIG. 8 is an operation sequence of the third exemplary embodiment of the present invention;

FIG. 9 is a functional block diagram of a fourth exemplary embodiment of the present invention; and

FIG. 10 is an operation sequence of the fourth exemplary embodiment of the present invention.

### DETAILED DESCRIPTION OF THE PREFERRED EMBODIMENTS

Exemplary embodiments of the present invention will be described in detail below with reference to the accompanying drawings.

### First Exemplary Embodiment

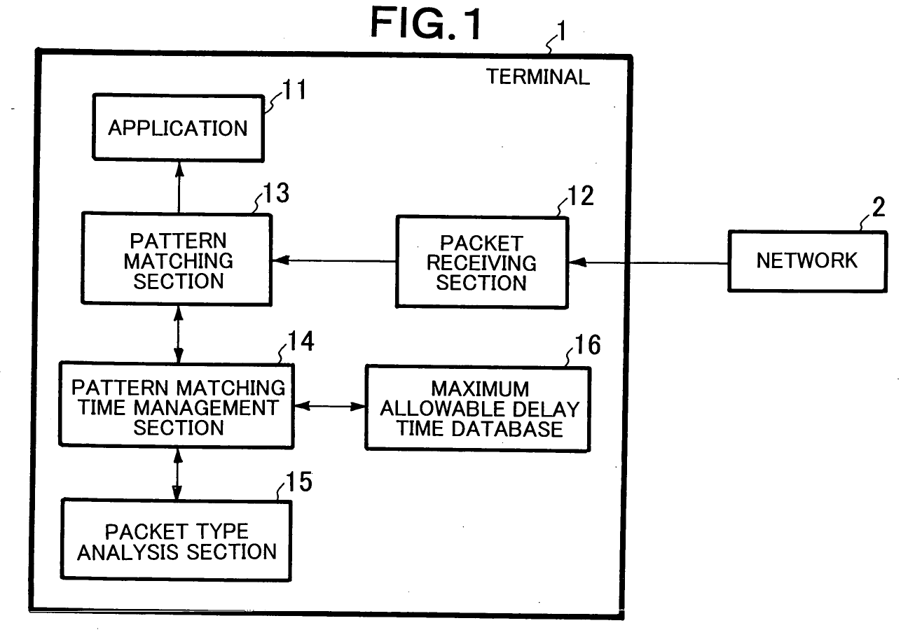

FIG. 1 is a functional block diagram of a first exemplary embodiment of the present invention. Referring to FIG. 1, a network 2 is a communication network, such as a TCP/IP (Transmission Control Protocol/Internet Protocol) network, to which a plurality of communication terminals are connected.

A terminal 1 is a communication apparatus connected to the network 2. The terminal 1 includes an application 11, a pattern receiving section 12, a pattern matching section 13, a pattern matching time management section 14, a packet type analysis section 15, and a maximum allowable delay time database 16.

The application 11 receives a packet and performs predetermined processing to the packet.

The pattern receiving section 12 receives a packet according to, e.g., a TCP/IP protocol stack. When the terminal 1 receives a packet from the network 2, the pattern receiving section 12 transfers the packet to the pattern matching section 13.

The pattern matching section 13 has an inline-type matching function of performing pattern matching between the packet transferred from the pattern receiving section 12 and an intrusion detection rule of an IDS. When it is determined as a result of the pattern matching that the packet is a normal one, the pattern matching section 13 transfers the packet to the application 11. On the other hand, when it is determined that the packet corresponds to an intrusion attack, the pattern matching section 13 makes a corresponding notification to an administrator and discards the relevant packet. Further, the pattern matching section 13 transfers a terminal reception packet to the pattern matching time management section 14 so as to set pattern matching processing time. In the exemplary embodiment, the pattern matching section 13 corresponds to the inline-type intrusion detection means (unit) of the present invention.

The pattern matching time management section 14 has functions of: receiving a packet from the pattern matching section 13; transferring the received packet to the packet type analysis section 15 so as to identify a protocol; managing the upper limit of an allowable delay time (hereinafter, referred to as “maximum allowable delay time”) according to the identified protocol; and notifies the pattern matching section 13 that the maximum allowable delay time is reached. In the exemplary embodiment, the pattern matching time management section 14 corresponds to the cancellation notification generation means (unit) of the present invention.

The packet type analysis section 15 has functions of receiving a terminal reception packet and analyzing the communication mode of the protocol of the received packet. The packet type analysis section 15 receives a terminal reception packet and returns a protocol identifier corresponding to the input packet.

When receiving the protocol identifier as an input, the maximum allowable delay time database 16 searches, using the protocol identifier as a key, for the maximum allowable delay time that has previously been defined in association with the protocol identifier and returns a result of the search to the pattern matching time management section 14 as a return value.

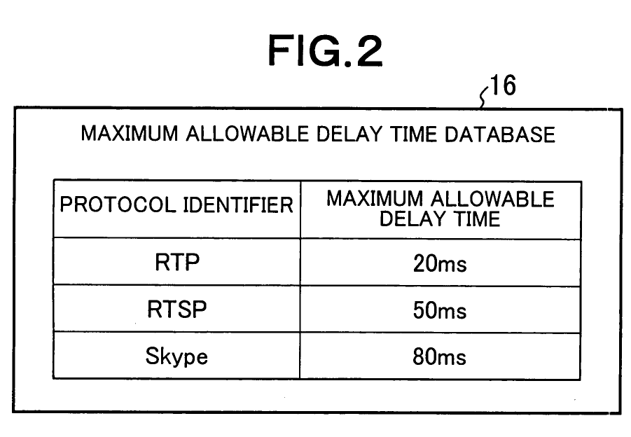

FIG. 2 is a view showing an example of the maximum allowable delay time database 16. The maximum allowable delay time database 16 includes protocol identifiers and their corresponding maximum allowable delay time.

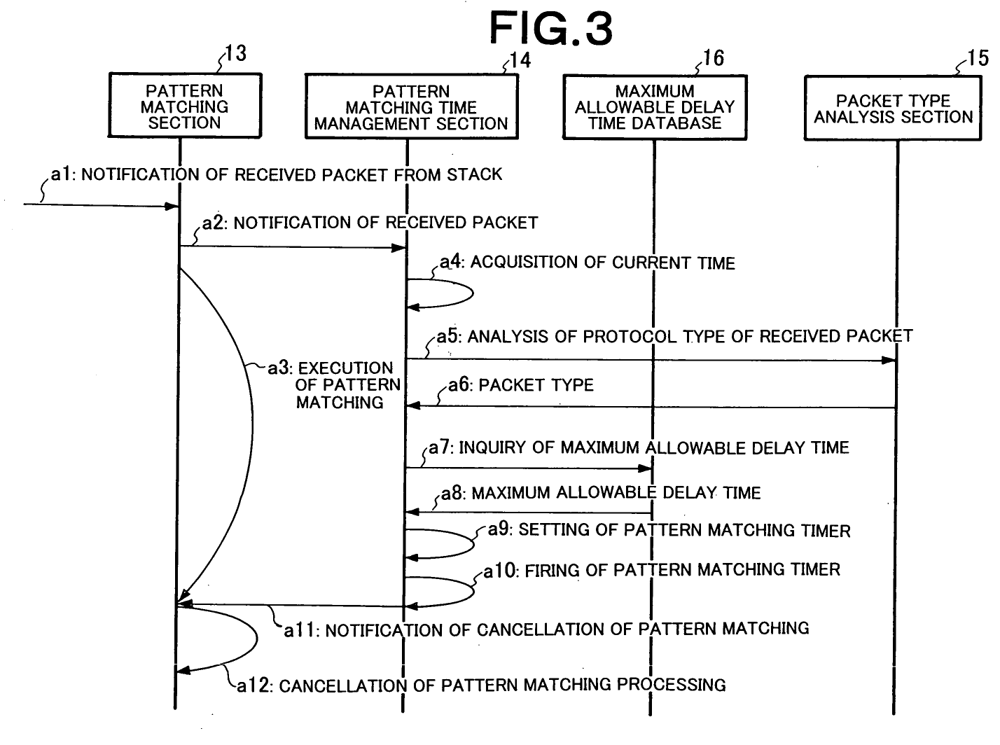

FIG. 3 is an operation sequence of the first exemplary embodiment of the present invention. With reference to FIG. 3, operation of the present exemplary embodiment will be described.

When receiving a packet from the network 2, the pattern receiving section 12 of the terminal 1 notifies the pattern matching section 13 of the received packet (step a1). The pattern matching section 13 then notifies the pattern matching time management section 14 of this terminal reception packet (step a2).

Further, the pattern matching section 13 executes packet matching processing. When determining as a result of the matching processing that the packet corresponds to an intrusion attack, the pattern matching section 13 discards the packet (step a3).

The pattern matching time management section 14 acquires the current time (step a4). The pattern matching time management section 14 notifies the packet type analysis section 15 of the terminal reception packet so as to request the packet type analysis section 15 to perform protocol analysis of the received packet (step a5).

The packet type analysis section 15 analyzes the protocol of the terminal reception packet based on the structure thereof. The packet type analysis section 15 returns a protocol identifier corresponding to the received packet to the pattern matching time management section 14 as an analysis result (step a6).

The pattern matching time management section 14 notifies the maximum allowable delay time information database 16 so as to know the upper limit of an allowable delay time (step a7).

The maximum allowable delay time information database 16 uses the notified protocol identifier as a key to search a database as shown in FIG. 2 and returns a maximum allowable delay time defined for each protocol as a result of the search to the pattern matching time management section 14 (step a8).

When receiving the packet from the pattern matching section 13, the pattern matching time management section 14 sets a time obtained by adding the current time acquired in step a4 and maximum allowable delay time as a wake-up timer event (step a9).

When the wake-up timer event is generated, the pattern matching time management section 14 fires the pattern matching timer (step a10). Then, the pattern matching time management section 14 notifies the pattern matching section 13 of cancellation of the pattern matching (step a11). Then, the pattern matching section 13 cancels the pattern matching processing and transfers normal packets to the application 11 (step a12).

By providing a function of canceling the pattern matching during execution thereof as described above, it is possible to ensure a real-time processing performance and to minimize lowering of security due to occurrence of unchecked packet.

### Second Exemplary Embodiment

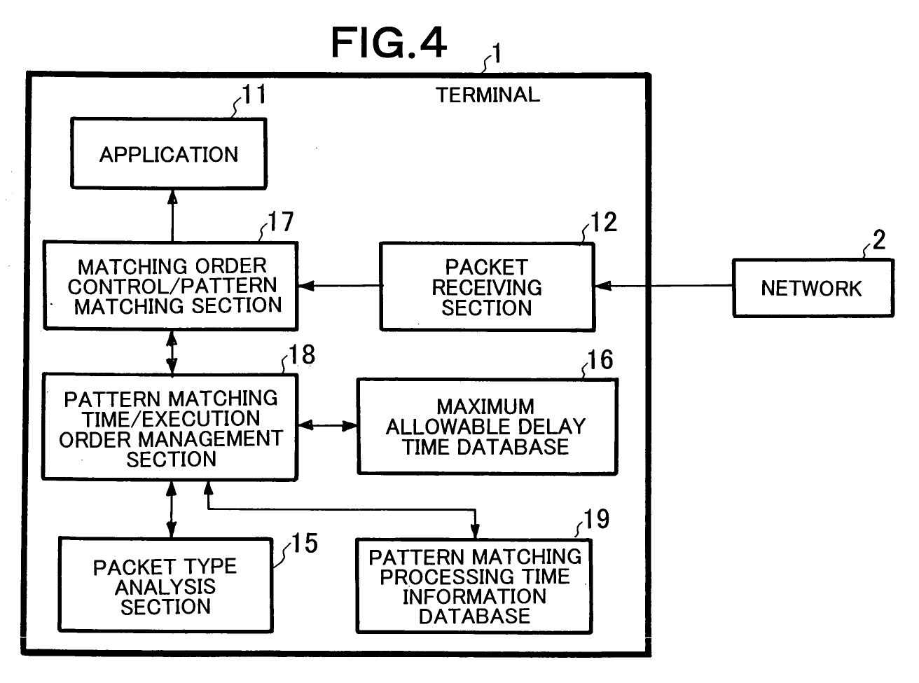

A second exemplary embodiment of the present invention will next be described with reference to FIGS. 4 to 6. FIG. 4 is a functional block diagram of the second exemplary embodiment of the present invention. In FIG. 4, the same reference numerals as those in FIG. 1 denote the same or corresponding parts as those in FIG. 1.

The terminal 1 according to the present exemplary embodiment additionally includes, with respect to the terminal of the first exemplary embodiment shown in FIG. 1, a function of changing the execution order of the intrusion detection rules depending on the importance of the detection rules.

In order to achieve this function, the pattern matching section 13 of FIG. 1 is replaced by a matching order control/pattern matching section 17 which has, in addition to the functions of the pattern matching section 13, a function of receiving an instruction concerning the execution order of the detection rules and performing the matching processing according to the execution order.

Further, the pattern matching time management section 14 of FIG. 1 is replaced by a pattern matching time/execution order management section 18 which has, in addition to the functions of the pattern matching time management section 14, a function of returning a pattern matching execution order list as a return value of the input packet.

Further, a pattern matching processing time information database 19 is newly provided in the terminal 1. The pattern matching processing time information database 19 has functions of receiving a protocol identifier as a key input and returning an intrusion detection rule detection rule execution order list in which the execution order of the intrusion detection rules is described by a list of intrusion detection rule identifiers to the pattern matching time/execution order management section 18.

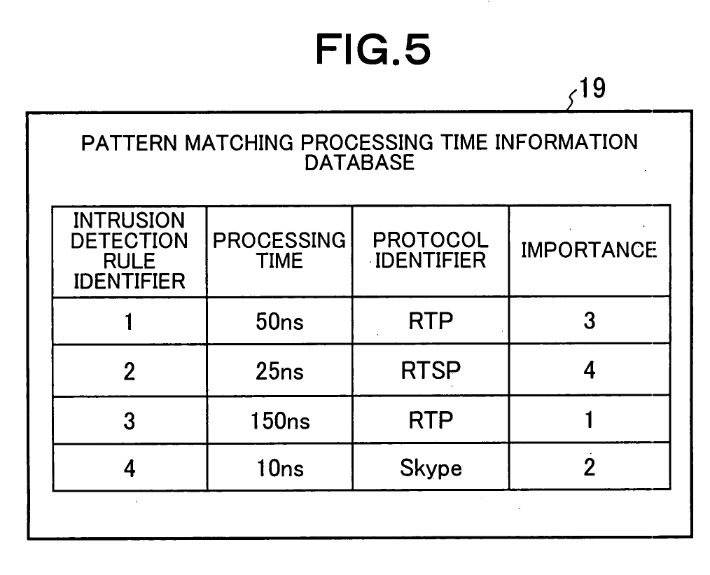

FIG. 5 is a view showing an example of the pattern matching processing time information database 19. As shown in FIG. 5, the pattern matching processing time information database 19 includes sets of intrusion detection rule identifier, processing time, protocol identifier, and importance. The other components of the terminal 1 are the same as those shown in FIG. 1, and the descriptions thereof will be omitted.

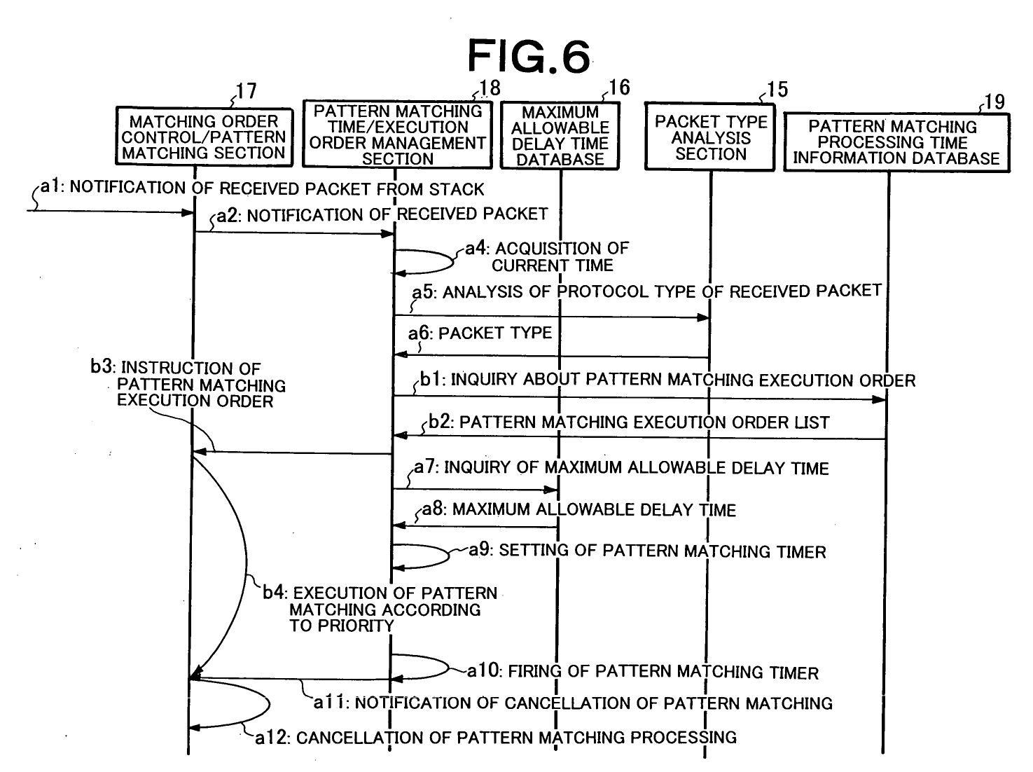

FIG. 6 is an operation sequence of the present exemplary embodiment. In FIG. 6, the same reference numerals as those in FIG. 3 denote the same or corresponding steps as those in FIG. 3, and only different points from FIG. 3 will be described.

The pattern matching time/execution order management section 18 receives, in step a6, a packet type from the packet type analysis section 15 as a return value and, after that, asks the pattern matching processing time information database 19 about the pattern matching execution order (step b1).

The pattern matching processing time information database 19 extracts sets corresponding to the protocol identifier from the table shown in FIG. 5 and changes the intrusion detection rule execution order according to the importance of the intrusion detection rules. In the case where the importance values of the intrusion detection rules are the same between the corresponding sets, a set having a shorter processing time is regarded as one having a higher importance value.

After the change of the intrusion detection rule execution order, the pattern matching processing time information database 19 returns the intrusion detection rule identifiers in the form of a pattern matching execution order list (step b2).

The pattern matching time/execution order management section 18 notifies the matching order control/pattern matching section 17 of the pattern matching execution order list obtained in step b2 as an argument (step b3).

The matching order control/pattern matching section 17 executes the pattern matching according to the pattern matching execution order list obtained in step b3 (step b4). Then, step a11 follows step b4. As a matter of course, steps a7 to a10 are executed in parallel with step b4.

As described above, the execution order of the intrusion detection rules can dynamically be changed in consideration of the importance and processing time at the communication (protocol) time at which real-time processing is required. Thus, it is possible to execute the matching processing starting from a packet having a higher importance in terms of security within the allowable delay time.

Therefore, even on a protocol providing a strict restriction on a delay, such as VoIP (Voice over Internet Protocol), it is possible to prevent a delay or occurrence of unchecked packets while executing pattern matching of a higher importance.

### Third Exemplary Embodiment

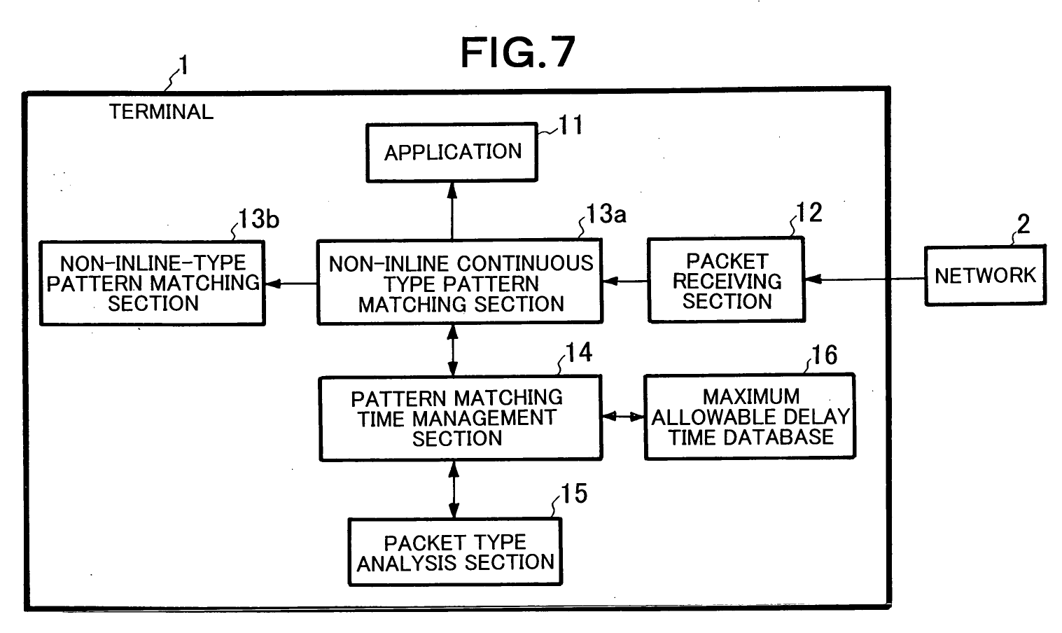

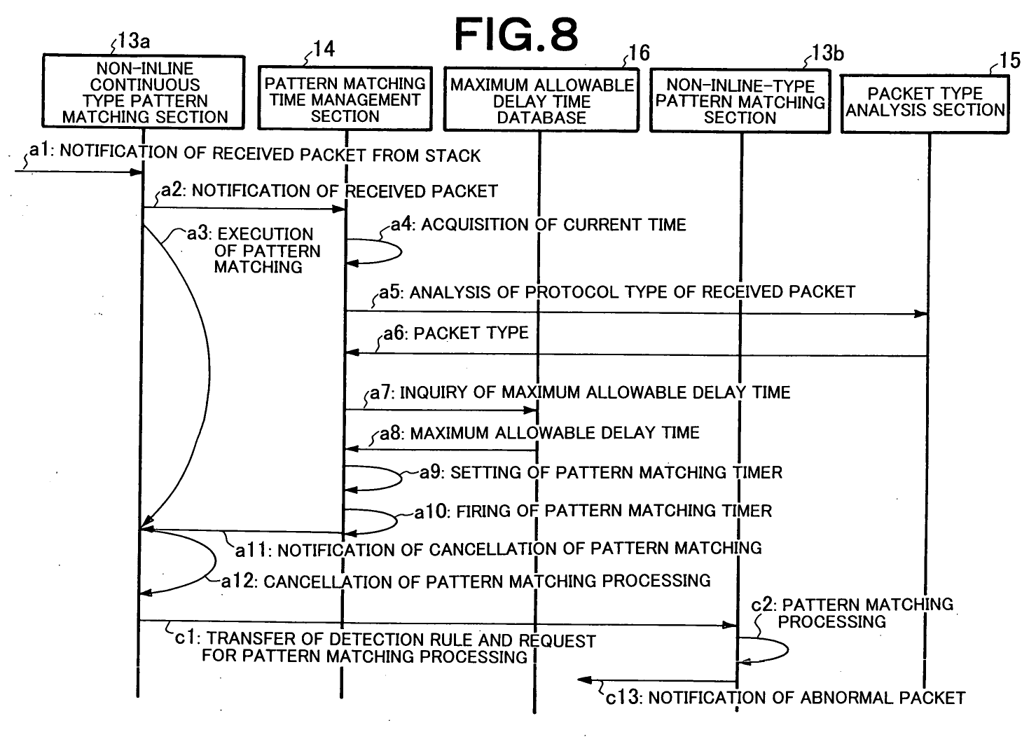

A third exemplary embodiment of the present invention will be described with reference to FIGS. 7 and 8. FIG. 7 is a functional block diagram of the third exemplary embodiment of the present invention. In FIG. 7, the same reference numerals as those in FIG. 1 denote the same or corresponding parts as those in FIG. 1.

The terminal 1 according to the first exemplary embodiment has a function of canceling the pattern matching processing; on the other hand, in the present exemplary embodiment, an intrusion detection rules that has not been subjected to the pattern matching is passed to a non-inline-type pattern matching section 13b to thereby allow the pattern matching to be performed even after the application 11 has started packet reception.

In order to achieve this function, a non-inline continuous type pattern matching section 13a and a non-inline-type pattern matching section 13b are provided in place of the pattern matching section 13 of FIG. 1.

The non-inline continuous type pattern matching section 13a has a function of passing a list of intrusion detection rule that have not been subjected to the pattern matching to the non-inline-type pattern matching section 13b when a notification of the cancellation of the pattern matching is sent to the pattern matching section 13 of FIG. 1.

The non-inline-type pattern matching section 13b has functions of receiving the list of intrusion detection rules from the non-inline continuous type pattern matching section 13a and executing the pattern matching for the terminal reception packet in parallel with the packet reception processing by the application 11.

Although the non-inline continuous type pattern matching section 13a and non-inline-type pattern matching section 13b are individually provided in the present exemplary embodiment, it is possible to integrate them as one function. In this case, when a notification of the cancellation of the pattern matching is sent, the packet that is being processed is passed to the application 11 and, at the same time, the pattern matching for the packet is continued.

Operation of the third exemplary embodiment will be described with reference to FIG. 8. In the present exemplary embodiment, steps c1 and c2 are executed after step a12 of FIG. 3. When receiving a notification of the cancellation of the pattern matching (step a11), the non-inline continuous type pattern matching section 13a cancels the pattern matching processing and passes the reception packet to the application 11 (step a12).

That is, the processing from step a1 to a12 is the same as that of the first exemplary embodiment. When receiving a notification of the cancellation of the pattern matching after step a12, the non-inline continuous type pattern matching section 13a passes an unexecuted intrusion detection rule to the non-inline-type pattern matching section 13b together with the reception packet (step c1).

The non-inline-type pattern matching section 13b executes the pattern matching corresponding to the unexecuted intrusion detection rule in parallel with the packet reception processing by the application 11 (step c2).

If the non-inline-type pattern matching section 13b determines that the packet that has been subjected to the pattern matching is an abnormal one, it sends to a corresponding notification to a given system such as the application or system administrator (step c13).

As described above, it is possible to realize a function of executing the pattern matching even after the application 11 starts the packet reception processing by passing the intrusion detection rule that has not been subjected to the pattern matching to the non-inline-type pattern matching section as well as a function of canceling the inline-type pattern matching processing, thereby preventing occurrence of unchecked packets.

### Fourth Exemplary Embodiment

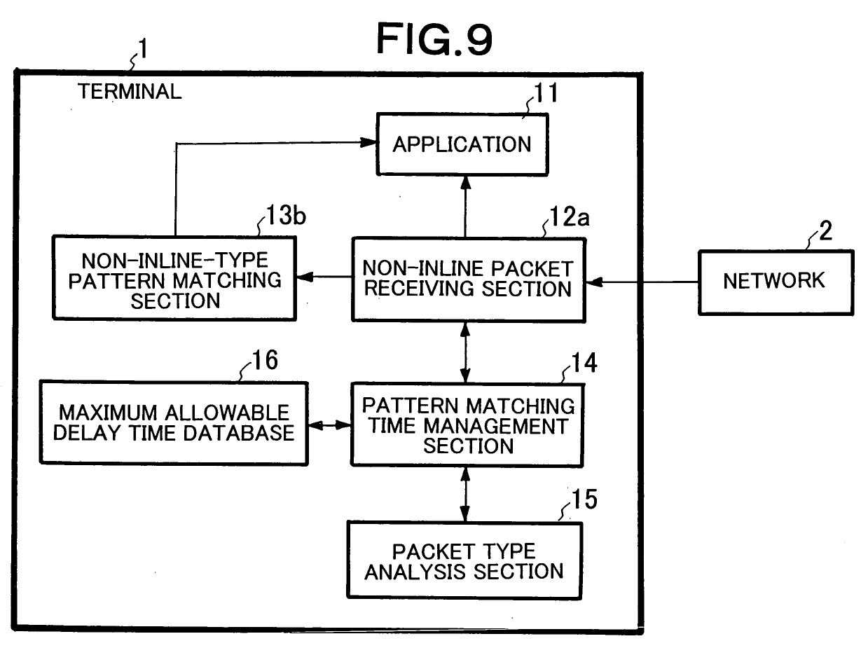

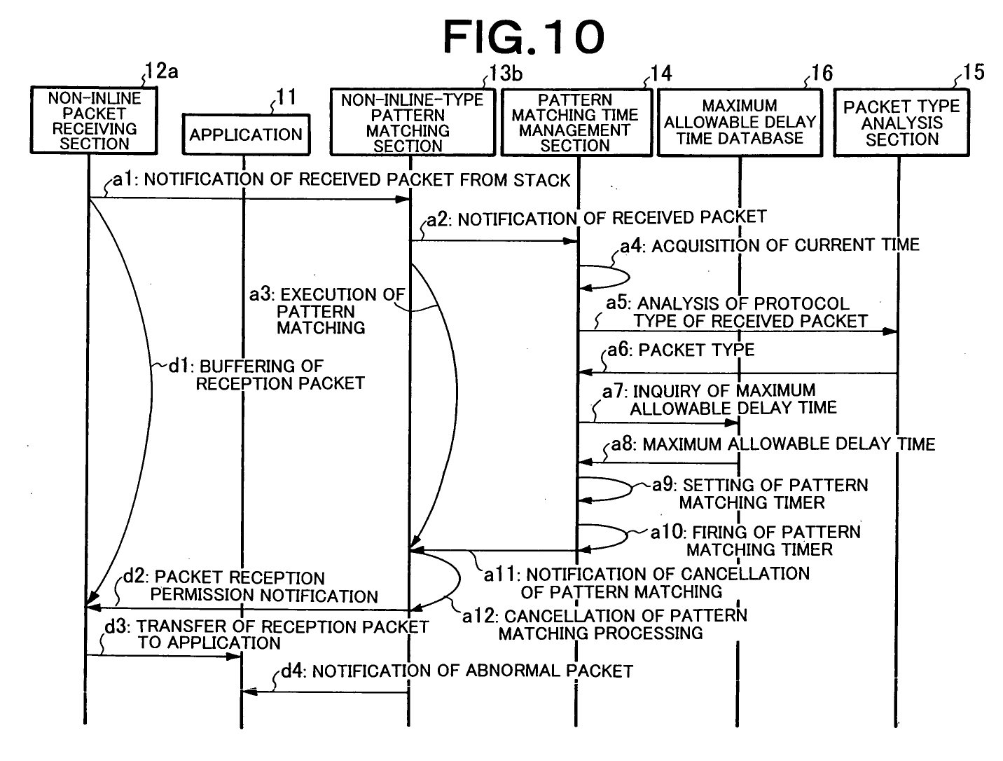

A fourth exemplary embodiment of the present invention will next be described with reference to FIGS. 9 and 10. FIG. 9 is a functional block diagram of the fourth exemplary embodiment of the present invention. In FIG. 9, the same reference numerals as those in FIGS. 1 and 7 denote the same or corresponding parts as those in FIGS. 1 and 7.

In the present exemplary embodiment, a function of delaying the packet reception processing of the application 11 until the maximum allowable delay time is reached is added to a communication apparatus having a non-inline-type intrusion detection function, allowing an abnormal packet detected within the maximum allowable delay time to be discarded.

As a result, even a communication apparatus having a non-inline-type intrusion detection function can maintain its real-time processing performance. Further, it is possible to prevent an abnormal packet detected within the maximum allowable delay time from being received by the application by discarding it.

In the present exemplary embodiment, a non-inline packet receiving section 12a is provided in place of the pattern matching section 13 of FIG. 1 as a packet receiving section.

The non-inline packet receiving section 12a has functions of receiving a packet, passing the received packet to the non-inline-type pattern matching section 13b for pattern matching, and delaying the packet transfer to the application 11 until the maximum allowable delay time is reached.

When the present exemplary embodiment is actually carried out, the non-inline packet receiving section 12a is implemented in a socket library, and readout of recv ( ) is; blocked until the maximum allowable delay time is reached. The other components of the terminal 1 are the same as those shown in FIG. 1, and the descriptions thereof will be omitted.

Operation of the present exemplary embodiment will be described with reference to a sequence diagram of FIG. 10. In this exemplary embodiment, steps d1 to d4 are executed after step a1 of FIG. 3.

When the non-inline packet receiving section 12a receives a packet, a notification of the reception packet is sent to the non-inline-type pattern matching section 13b (step a1). At the same time, the reception packet is buffered in a not shown buffer provided inside the non-inline packet receiving section 12a until a notification of the cancellation of the pattern matching is sent thereto and thereby the reception packet is not passed to the application 11 (step d1).

When the pattern matching is canceled (step a12) and a packet reception permission notification is sent from the non-inline-type pattern matching section 13b to non-inline packet receiving section 12a (step d2), the non-inline packet receiving section 12a passes the buffered packet to the application 11 (step d3). The non-inline-type pattern matching section 13b continues the pattern matching and, if the packet is an abnormal one, sends to a corresponding notification to a given system such as the application or system administrator (step d4).

The operations in the above exemplary embodiments can previously be stored as a program in a recording medium such as an ROM (Read Only Memory) and executed by allowing a computer (CPU: Central Processing Unit) to read the program. As the communication terminal 1, a personal computer (including portable type), a mobile communication terminal, a network appliance, and a sensor device can be mentioned. In particular, by applying the present invention to an apparatus whose performance of hardware resources such as processor or memory is limited, the processing delay due to IDS processing can effectively be minimized.

Further, in the above exemplary embodiments, the application 11 is merely an exemplar and it includes a predetermined program such as a system or application.

While the invention has been particularly shown and described with reference to exemplary embodiments thereof, the invention is not limited to these embodiments. It will be understand by those of ordinary skill in the art that various changes in form and details may be made therein without departing from the spirit and scope of the present invention as defined by the claims.

What is claimed is:

1. An intrusion detection system which performs pattern matching between a reception packet and an intrusion detection rule, comprising:
inline-type intrusion detection means for performing pattern matching between the reception packet and the intrusion detection rule before an application processes the reception packet; and
cancellation notification generation means for generating a pattern matching cancellation notification while the pattern matching is performed by the inline-type intrusion detection means, wherein
the inline-type intrusion detection means is configured to cancel the pattern matching in response to the pattern matching cancellation notification.

2. The intrusion detection system according to claim 1, further comprising:
non-inline-type intrusion detection means for performing pattern matching between a reception packet and a intrusion detection rule while the application processes the reception packet; and
means for taking over the pattern matching from the inline-type intrusion detection means to the non-inline-type intrusion detection means in such a manner that the non-inline-type intrusion detection means performs the pattern matching using the intrusion detection rule that has not been subjected to the pattern matching by the inline-type intrusion detection means due to the cancellation of the pattern matching.

3. The intrusion detection system according to claim 2, further comprising:
means for generating a notification indicating abnormality when an abnormal packet is detected in the pattern matching performed by the non-inline-type intrusion detection means.

4. The intrusion detection system according to claim 2, further comprising:
means for delaying reception of the packet until the maximum allowable delay time is reached; and
means for continuing the pattern matching after reception of the packet.

5. The intrusion detection system according to claim 1, wherein
the cancellation notification generation means determines the maximum allowable delay time for the reception packet and generates the pattern matching cancellation notification when the processing time of the pattern matching for the reception packet reaches the maximum allowable delay time.

6. The intrusion detection system according to claim 5, wherein
the cancellation notification generation means determines the maximum allowable delay time depending on the protocol type of the reception packet.

7. The intrusion detection system according to claim 1, further comprising:
means for controlling the order of the intrusion detection rule used in the pattern matching depending on the importance of the intrusion detection rule or the length of the matching processing time in the pattern matching performed by the inline-type intrusion detection means.

8. A communication apparatus which uses the intrusion detection system according to claim 1.

9. An intrusion detection method for performing pattern matching between a reception packet and an intrusion detection rule, comprising:
an inline-type intrusion detection step of performing pattern matching between the reception packet and the intrusion detection rule before an application processes the reception packet;
a cancellation notification generation step of generating a pattern matching cancellation notification while the pattern matching is performed in the inline-type intrusion detection step; and
a step of canceling the pattern matching in response to the pattern matching cancellation notification generated in the inline-type intrusion detection step.

10. The intrusion detection method according to claim 9, further comprising:
a non-inline-type intrusion detection step of performing pattern matching between a reception packet and a intrusion detection rule while the application processes the reception packet; and
a step of taking over the pattern matching from the inline-type intrusion detection step to the non-inline-type intrusion detection step in such a manner that, in the non-inline-type intrusion detection step, the pattern matching is performed by using the intrusion detection rule that has not been subjected to the pattern matching in the inline-type intrusion detection step due to the cancellation of the pattern matching.

11. The intrusion detection method according to claim 10, further comprising:
a step of generating a notification indicating abnormality when an abnormal packet is detected in the pattern matching performed in the non-inline-type intrusion detection step.

12. The intrusion detection method according to claim 10, further comprising:
a step of delaying reception of the packet until the maximum allowable delay time is reached; and
a step of continuing the pattern matching after reception of the packet.

13. The intrusion detection method according to claim 9, wherein
the cancellation notification generation step determines the maximum allowable delay time for the reception packet and generates the detection rule matching cancellation notification when the processing time of the pattern matching for the reception packet reaches the maximum allowable delay time.

14. The intrusion detection method according to claim 13, wherein
the cancellation notification generation step determines the maximum allowable delay time depending on the protocol type of the reception packet.

15. The intrusion detection method according to claim 9, further comprising:
a step of controlling the order of the intrusion detection rule used in the pattern matching depending on the importance of the detection rule or the length of the matching processing time in the pattern matching performed in the inline-type intrusion detection step.

16. An intrusion detection program, stored in a computer-readable medium, for allowing a computer to execute pattern matching between a reception packet and an intrusion detection rule, comprising:
an inline-type intrusion detection processing of performing pattern matching between the reception packet and the intrusion detection rule before an application processes the reception packet;
a cancellation notification generation processing of generating a pattern matching cancellation notification while the pattern matching is performed in the inline-type intrusion detection processing; and
a processing of canceling the pattern matching processing in response to the pattern matching cancellation notification generated in the inline-type intrusion detection processing.
